(19) United States
(12) Patent Application Publication
(10) Pub. No.: US 2014/0334252 A1
(43) Pub. Date: Nov. 13, 2014

(54) MULTI-CHAMBER MIXING CONTAINER

(71) Applicant: B. BRAUN MELSUNGEN AG, MELSUNGEN (DE)

(72) Inventors: Ralf Harand, Guxhagen (DE); Volker Krueger, Nieste (DE); Joachim Beine, Guxhagen (DE); Sandra Vonhof, Melsungen (DE)

(73) Assignee: B. Braun Melsungen AG, Melsungen (DE)

(21) Appl. No.: 14/361,615

(22) PCT Filed: Dec. 20, 2012
(86) PCT No.: PCT/EP2012/076518

§ 371 Date: May 29, 2014

(30) Foreign Application Priority Data
Dec. 22, 2011 (EP) 11075274.8

(51) Int. Cl. B01F 15/02; B65D 81/32; B01F 13/00; B01F 3/08; B01F 3/12

(52) U.S. Cl. CPC B01F 15/0212; B01F 3/08; B01F 3/12; B01F 13/0023; B65D 81/32; B01F 2215/0032
USPC 366/348; 206/222

(57) ABSTRACT

The invention is related to a multi-chamber mixing container comprising an introversion container, a withdrawal container and various optionally present intermediate containers, furthermore a device for the reception and use of the multi-chamber mixing container and methods for mixing liquids or liquids and solids under aseptic conditions in the multi-chamber mixing container.

### CROSS REFERENCE TO RELATED APPLICATIONS

This application is the U.S. national phase application of PCT International Application No. PCT/EP2012/076518 filed Dec. 20, 2012, which claims priority to European Patent Application No. EP 11075274.8 filed Dec. 22, 2011, the contents of each application being incorporated by reference herein.

### FIELD OF THE INVENTION

The invention is related to a multi-chamber mixing container consisting of introversion container, withdrawal container and various optionally present intermediate containers as well as the use of the multi-chamber mixing container and methods for mixing liquids or liquids and solids under aseptic conditions in the multi-chamber mixing container.

### BACKGROUND

Multi-chamber mixing systems serve for blending two or several components, especially of such like that shall be in contact with each other only for a short time. Many single components are unstable in solution or as a mixture with other components so that it is advantageous to store the components separately and to mix them with each other or to bring them into solution only shortly before the use of the components. This applies, e.g., to solutions for medical uses, but also to industrial applications such as the application of paint, mixture of chemicals or the use in the production of materials.

### DESCRIPTION OF THE RELATED ART

It is necessary in many medical, dental or veterinary medical applications to mix the components of a solution with each other just short before the use or administration. These compounds and formulations can comprise liquid components but also solid components, e.g. powders. Many active agents are not stable in diluted solutions or in general in dissolved form, so that the mixture and administration of solutions in a short space of time is desired very much. For the mixture of liquids and/or solids different systems are known. For example in the prior art first and foremost syringe-like containers for mixing two or more components are known, wherein most systems are two-chamber mixing systems, wherein both chambers are integral parts of the system and cannot be exchanged or combined at one's convenience. Thus, most systems are pre-fabricated industrially.

In US2007/0185438 a device is disclosed, in which the single components of a multi-component mixture are retained in different chambers of an ampulla with several chambers. For the mixture of the components the containers are pushed through with a plunger element belonging to the device. Thereby a collected volume arises from several chambers. The ampulla can be inserted into a syringe-like device and directly be used as syringe for the administration of the mixture by the use of a mounted needle. Here, the components are predetermined in the ampulla due to the pre-fabrication and not freely combinable with each other, neither in regard to the content nor to the required quantity or concentration.

The application US2010/0121310 is related to a multi-chamber cartridge, in which two or several chambers are arranged along the longitudinal axis, and to which additionally two plungers belong by means of whom the components can be mixed and also the mix can be used due to a nozzle.

Also WO2010051369A1 is related to syringe-like devices, in which a cylinder can also be divided into several sections, which can be filled differently, and a plunger within the cylinder empties the content like in a syringe. Multi-chamber embodiments are also disclosed in WO2010051369A1, wherein the single compartments are separated from each other by intermediate walls, which can be pushed through by the plunger. These intermediate walls are denoted as thin foils, but which will not come off completely but will attach to the inner cylinder wall and will thereby stop the further advance of the plunger. It is thus obvious that the multi-chamber systems disclosed in WO2010051369A1 will not be functioning, because the plunger has to glide form-fit in the cylinder and the severed intermediate walls have a finite thickness and will therefore inhibit the further advance of the plunger. By application of a considerably higher pressure it might be possible to slide the plunger over the severed intermediate walls or push the severed intermediate walls with the plunger to the front, wherein in doing so the great danger exists, that the barrier built by the severed intermediate walls is overcome spontaneously and then the content of the syringe is applied to the patient with a pressure considerably too high. Moreover, there is also the fact, that for the gliding of a plunger in a cylinder either glass can be used as material, which has good gliding properties, but then the intermediate walls cannot be introduced technically and upon transection of the intermediate walls the interstice between the outer surface of the plunger and inner wall of the cylinder is plugged and the plunger cannot be advanced further or in case of the use of synthetic material as material for the cylinder and the plunger, the inner surface of the cylinder has to be siliconized in order to ensure sufficient gliding properties. However, a siliconized surface is unfeasible for many chemical active agents and biological substances, because these substances are denaturized or decomposed at siliconized surfaces. The embodiments according to WO2010051369A1 seem, thus, only to function without intermediate wall, as has been also demonstrated by the inventors of the present invention.

GB787090A discloses a single container that can be inserted in a syringe cylinder and is emptiable via introversion, wherein no individual combination of several single containers is envisaged here.

The disclosed devices are in each case pre-fabricated and bound to the availability of syringe-like cartridge systems. Herein, the compartments within a pre-fabricated ampulla or cartridge or syringe or the like are separated by membranes or solid walls, but after manufacture and filling of the compartments by the manufacturer no variation of the single components, so for example exchange or alteration in the order within the assembly are possible. Moreover, in the prior art the number of compartments once pre-fabricated cannot be varied anymore. A further disadvantage of the embodiments of the prior art is that always needle- or plunger-like parts are integral parts of the device, which are required for puncture and mixing.

### SUMMARY OF THE INVENTION

It is an objective of the present invention to provide a device that is suited for the mixture of at least two components, wherein the components and also the number of the components shall be variable, and which shall be further designed in such a way that the implementation of needles and plungers in the device are not necessary for mixing the solutions. Hence, a system shall be provided that enables the physician to freely combine solvents and active agents in type, concentration and quantity in order to administer a specific active agent in a specific concentration in a specific solvent at one's convenience.

This objective is solved by the provision of multi-chamber mixing containers and the methods described herein. Additional advantageous embodiments, aspects and details of the invention result from the dependent claims, the description, the examples and the figures.

It has surprisingly been found that the multi-chamber mixing container according to aspects of the invention for the provision and mixture of the components solves the posed objective. The multi-chamber mixing container according to aspects of the invention serves for the separate storage of at least one solvent and a liquid or a active agent, which is for example more stable in the lyophilized, spray-dried or freeze-dried state than in the dissolved state, so that a separate storage of solvent and active agent can take place in the multi-chamber mixing container and the aseptic through-mixing short before the application can be conducted as well in the multi-chamber mixing container according to aspects of the invention.

Among the active agents, which can preferably be retained for parenteral applications in the multi-chamber mixing container, are for example antibiotics, analgesics, anti-inflammatory active agents, steroids, antiproliferative, immunosuppressive, fungicidal, cytostatic, antimigratory, antiphlogistic, cytotoxic, anti-angiogenic and/or antithrombotic active agents. Liquids for the dissolution or mixture comprise double-distilled water, isotonic sodium chloride solution, various other isotonic salt solutions or physiologically acceptable buffers.

The term “liquid”, as used herein, refers not only to solvents for a solid, a mixture of solids, a gel, a paste, another liquid substance or a liquid mixture, but also to solutions of solid substances, emulsions or dispersions or two-phase liquid mixtures.

The multi-chamber mixing container according to aspects of the invention consists in the simplest embodiment of the introversion container and a withdrawal container, which are aseptically connected with each other. The solvent is situated in the introversion container and the active agent(s) in solid, gel-like or liquid form in the withdrawal container. The active agent or the combination of active agents in the withdrawal container is preferably a solid, which can be stored longer as a solid than in solution, so that the active agent solution shall be prepared not until short before the application. Generally, the multi-chamber mixing container is suited for the storage of active agents, which are longer stable without solvent than in a solvent, wherein the solvent also includes buffers. However, the multi-chamber mixing container is exceptionally intended to allow the physician the combination of single containers, so that a physician can select a container with a specific active agent in a specific quantity and to combine it with a container with a specific solvent in a specific quantity, in order to prepare in such a way an individual mixture of a specific active agent in a specific concentration in a specific quantity of a specific solvent.

If it is necessary to store several active agents or several solvents or a liquid active agent and a solid active agent separated from the solvent, the inventive multi-chamber mixing container apart from the introversion container and the withdrawal container can also have one, two or several intermediate containers as well, which are situated between the introversion container and the withdrawal container and preferably serve for the uptake of one component each.

Introversion container, withdrawal container and intermediate container are termed generically also as component containers.

The component containers are sealed, wherein the closure of the component containers is realized preferably via a seal with a sealing foil. It is the purpose of the component containers to keep the content sterile and germ-free. The component containers according to aspects of the invention have in addition preferably at least one centering groove, indentation, a bead, a thread or also a trunnion in the lateral surface. These are advantageous, because a mechanical support of the container(s) can be ensured in an arrangement of the component container(s) in a device for the through-mixing.

So all component containers, i.e. two (bi-system), three (tri-system), four (quad-system) or in the most general sense several component containers (multi-system) are connected with each other in a form-fit, force-fit or a firmly bonded manner and aseptically. The design of the component containers enables additionally the connection of several component containers into a bi-, tri- or quad-system in order to separately store several substances of content incompatible over a longer period of time and to mix them with each other shortly before the application.

The present invention is therefore not only related to readily assembled multi-chamber mixing containers but also to a kit from at least one introversion container, at least one withdrawal container and optionally at least one intermediate container, which can be combined with each other individually.

Herein, a bi-system consists of one introversion container and one withdrawal container, a tri-system of one introversion container, one intermediate container and one withdrawal container and a quad-system of one introversion container, one first intermediate container, one second intermediate container and one withdrawal container. Herein, each component container can take up a component or also a mixture of components of the solution later to be prepared, retain it separate from the other components as well as keep it sterile and germ-free. Also the connection of the component containers with each other happens aseptically.

Optionally, the component containers can each have a joining edge or a thread, that enables the joining of a component container with one or two additional component container(s), mediates a mechanical support to the connection, and facilitates the closure of the connection to the outside.

Various embodiments of the component containers belong to the invention. The introversion container is preferably a container for liquids. An introversion container according to aspects of the invention has an introversible sidewall, a sealable front side, furthermore preferably an internal nose or protrusion, which can be moved axially by eversion of the sidewall, for piercing the sealing foil, and preferably at least one centering groove or indentation in the wall (FIG. 1). The introversible sidewall is advantageous, because thereby an impression of a container surface by external pressure is enabled. The invaginable parts of the side wall are preferably softer, so weaker in the nature of the material, in order to enable an easier impression, without the material being damaged or a too high effort being necessary. Herein, the impression or invagination is preferably supported by so-called notch lines in order to enable an easier impression. The notch lines are characterized by a transition to a stronger or weaker nature of the material, which changes the introversion characteristics such as for example a taper or thickening in the material or of the wall, a predetermined folding point or predetermined folding line or a purposeful weak spot in the material or of the wall.

A further component container is the withdrawal container. The withdrawal container is characterized in its outer shape by front side, sidewall and closure side. As with the introversion container, the front side is sealed by a pierceable sealing foil. Herein, the withdrawal container can contain a liquid or a solid substance. Solid substances are preferably in powder form, also preferably lyophilized and further preferably freeze-dried. Herein, the shape of the withdrawal container is preferably adapted to that of the introversion container, i.e. the diameter and the shape of the front side corresponds to that of the introversion container, whereby a tight, so firmly bonded connection between both component containers can be ensured. The withdrawal container preferably has a closure system at his closure side, by which the withdrawal container is hermetically sealed and the content can be withdrawn with a cannula (FIG. 2). Alternatively, the content of the withdrawal container or of the multi-chamber mixing container can be drained via a needle-free access.

Moreover, a device is disclosed herein, into which the multi-chamber mixing container can be inserted and preferably be fixed via corresponding cut-outs in the device. The device is in the shape of a half-shell and has an expression plunger movable in axial direction. This device is a carpule-like system that can be used for the through-mixing of the substances of contents of the component containers (FIG. 3). The device is preferably carried out as receptacle in the shape of a half-shell with one or several centering grooves in the connection plane of the component containers, which center the multi-chamber mixing container and stabilize its position. The device for a multi-chamber mixing container with one, two or more intermediate containers is in principle constructed similarly, solely length and number of the preferably present centering grooves are adapted to the respective configuration. By the exertion of pressure onto the bottom of the introversion container by the expression plunger and a subsequent movement of the expression plunger in the direction of the sealing foil, which is also in direction of the withdrawal container, the introversion container is impressed and its wall is introverting to the inside. With onward movement of the expression plunger in the direction of the withdrawal container, the bottom of the introversion container pushes through the sealing foil of the introversion container and afterwards the sealing foil of the withdrawal container and the liquid from the introversion container can pass over into the withdrawal container and dissolve the substance (FIG. 4). The solution freshly prepared in such a way can be withdrawn from the withdrawal container via a withdrawal area such as for example a plug or a septum. For the complete emptying of the multi-chamber mixing container the introversion container can be introverted completely into the withdrawal container until the bottom of the introversion container is in contact with the withdrawal area of the withdrawal container (FIG. 3).

### DETAILED DESCRIPTION OF THE PREFERRED EMBODIMENTS

It has surprisingly been found that a multi-chamber mixing container for the separate storage and mixture of the contained components solves the posed objective, wherein the multi-chamber-mixing container according to aspects of the invention consists of or comprises an introversion container and a withdrawal container filled with a liquid or a solid, wherein introversion container and withdrawal container are connected with each other in a sealing manner, the withdrawal container is sealed on the top side with a pierceable sealing foil and has a withdrawal area at the bottom side.

Thus, the multi-chamber mixing container according to aspects of the invention consists in the simplest embodiment of an introversion container and a withdrawal container, wherein the introversion container is always filled with a liquid. The withdrawal container preferably contains a solid or a mixture of solids, but can also contain a further liquid or a liquid mixture or a solution of one or several substances in a solvent. Preferably, the component contained in the withdrawal container is longer stable, if it is stored separately from the liquid in the introversion container than if the component contained in the withdrawal container is dissolved in the liquid. By introversion of the introversion container at least partially into the withdrawal container the transection of the partition between the two component containers takes place and the component contained in the withdrawal container can be dissolved in the liquid contained in the introversion container.

Thus, the present invention is related to a multi-chamber mixing container comprising or consisting of an introversion container and a withdrawal container, wherein the introversion container is filled with a liquid and sealed with a pierceable sealing foil on the front side and its bottom can be pushed in the direction of the sealing foil and the wall is introversible to the inside and the withdrawal container is filled with a liquid or a solid and sealed on the top side with a pierceable sealing foil and has a withdrawal area at the bottom side and introversion container and withdrawal container are connected with each other in a sealing manner. A plug, septum, valve, fastening, screw cap or other fastenings for the connection with a cannula or a tube can serve as withdrawal area.

Preferably, the front side of the introversion container sealed with a pierceable sealing foil is connected in a sealing manner with the top side of the withdrawal container sealed with a pierceable sealing foil.

Moreover, it is preferred, if the outer face of the introversion container has a groove, a bead, a thread or a recess at the level of the sealing foil and/or the withdrawal container has a groove, a bead, a thread or a recess at the level of the sealing foil. This groove, bead, thread or recess can on the one side serve for the fixation of the multi-chamber mixing container in the device for the reception of the multi-chamber mixing container as well as for the sealing connection of both component containers with each other. It goes without saying that in a sealing connection of two component containers with each other the groove of the first component container has to fit to the groove of the other one or the bead of the first component container has to fit to the bead of the other one or the thread of the first component container has to fit to the thread of the other one or the recess of the first component container has to fit to the projection of the other component container in a form-fit manner, so that a sealing connection can be established maybe after a glue-, radiation- or heat-treatment step.

In a further embodiment the multi-chamber mixing container consists of the introversion container according to aspects of the invention and the withdrawal container and an intermediate container filled with a liquid or a solid and located in between introversion container and withdrawal container, wherein the intermediate container is sealed on the top side and on the bottom side with a pierceable sealing foil and the intermediate container is connected with the introversion container in a sealing manner and with the withdrawal container in a sealing manner.

In another embodiment the multi-chamber mixing container consists of the introversion container and the withdrawal container and two intermediate containers each filled with a liquid or a solid and located in between introversion container and withdrawal container, wherein both intermediate containers are sealed on the top side and on the bottom side with a pierceable sealing foil and both intermediate containers are connected with each other in a sealing manner and the first intermediate container is connected with the introversion container in a sealing manner and the other intermediate container is connected with the withdrawal container in a sealing manner.

So the multi-chamber mixing container according to aspects of the invention always consist of the introversion container, which contains a liquid, and the withdrawal container, which contains a solid or liquid component, and optionally one, two or more intermediate container positioned in between introversion container and withdrawal container, wherein each component container is connected with the adjacent component container in a sealing manner, i.e. preferably aseptically welded or glued, and the component containers' faces connected in a sealing manner are sealed with a sealing foil. This construction principle enables the manufacture and filling and sealing of the single containers under aseptic conditions, which are only then assembled into the multi-chamber mixing container according to aspects of the invention.

The term “connected in a sealing manner” or “connectable in a sealing manner” describes the property, that two component containers are connected or connectable by a welded connection, glued connection, thread or differently in such a way that no content from the multi-chamber mixing container can escape through this sealing connection at the pressure to be build up for the emptying of the multi-chamber mixing container.

Furthermore an aspect of the present invention is related to a kit comprising at least one introversion container that is sealed with a pierceable sealing foil on the front side and its bottom can be pushed in the direction of the sealing foil and the wall is introversible to the inside and at least one withdrawal container that is sealed on the top side with a pierceable sealing foil and has a withdrawal area at the bottom side, wherein introversion container and withdrawal container are connectable with each other in a sealing manner.

Preferably, the at least one introversion container is filled or more preferably completely filled with a liquid such as for example a solvent, a buffer or active agent solution. This kit can additionally comprise at least one intermediate container that is sealed on the top side and on the bottom side with a pierceable sealing foil, wherein the intermediate container is connectable with the introversion container in a sealing manner and with the withdrawal container in a sealing manner.

All component containers in this kit are preferably pre-filled and can be combined with each other at one's convenience. A kit according to aspects of the invention can thus comprise several introversion containers, which are for example filled with different buffers as well as introversion containers with different quantities of for example physiological sodium chloride solution. The intermediate containers of the kit can contain for example solutions or solids of vitamins, salts or dietary supplements in various compositions and quantities and the withdrawal containers can contain an active agent or a mixture of active agents as solid or as solution. Such a kit enables a physician for example in case of a flu vaccination to select depending on gender, age and weight of the patient and to combine individually an introversion container with a 0.5 M sodium chloride solution, an intermediate container with 0.5 g vitamin C, folic acid and a few B vitamins and a withdrawal container with a specific antibiotic in a specific quantity and after merging of the components in the multi-chamber mixing container to administer it as a homogenous solution.

The preparation and preferably the aseptic preparation of a solution of the components can take place according to the following method, so that an aspect of the present invention is also directed to a method for the aseptic preparation of a solution from at least two components, further comprising the insertion of a multi-chamber mixing container according to aspects of the invention in a device comprising a receptacle in the shape of a half-shell for the multi-chamber mixing container, mounting means for the multi-chamber mixing container and an expression plunger movable in axial direction, exertion of pressure by the expression plunger onto the bottom of the introversion container, pushing the bottom of the introversion container in the direction of the withdrawal container, whereat the wall of the introversion container is continuously introverting to the inside and with onward pushing the sealing foils are pierced and mixing of the at least two components.

In this kit or in the assembled form as multi-chamber mixing container the introversion container further comprises a bottom that can be pushed towards the inside, an opposite face sealed with a sealing foil and a wall introversible to the inside. The intermediate container further comprises a stable wall, i.e. non-introversible, a wall introversible up to a part of the height of the container or a wall completely introversible and a top side sealed with a sealing foil as well as a bottom side sealed with a sealing foil. The withdrawal container further comprises an area, the withdrawal area, through which the solution prepared within the multi-chamber mixing container can be withdrawn, preferably with a needle, a cannula or also in a needle-free manner, an opposite side sealed with a sealing foil and a stable, i.e. non-introversible wall. In addition, all component containers have a regular geometry of their cross sectional area and are preferably round or oval, so that an invagination of the introversion container can take place as conveniently as possible. In addition, the component containers preferably have the same inner radius, so that they can be assembled fittingly and the connecting line or the connecting edge fit on top of each other. The multi-chamber mixing container is, thus, preferably cylindrical with a flat or inwardly curved bottom, namely the bottom of the introversion container, and a withdrawal area at the head end in form of a cap, crimp cap, screw cap, plug or the like, compartments separated from each other by sealing foils and an elongated preferably cylindrical corpus.

The component containers or introversion containers and withdrawal containers are connected with each other in such a way, that the sealing foils lie on top of each other in short distance. For the form-fit, force-fit, material-fit and/or firmly bonded, i.e. sealing and aseptic connection the component containers are preferably connected with each other by plugging, screwing, gluing, forcing in, but especially preferred by welding, so that during blending of the contents no leakage occurs and the aseptic content still remains sterile and germ-free. The connection is conducted independently of the joining method aseptically, thus, under sterile conditions, so that no germs find their way into the interstice between the sealing foils. The optionally present joining edge gives a mechanical support to the connection and contributes further to the sealing of the connection. Also possible is a closure of the component container via complete welding or fusion of the component container material or of a coating with a liquid-impermeable material such as plastic, a corrosion-resistant metal or a polymer.

The multi-chamber mixing container resulting from the connection of the component containers preferably has a cylindrical shape, which is defined by the shape of the component containers. Thus, the multi-chamber mixing container corresponds in shape and diameter to introversion container and withdrawal container and also to the optional intermediate container.

The sealing foils opposing each other of introversion- and withdrawal container in the bi-system or of introversion-, intermediate- and withdrawal container in the tri-, quad-system or multi-system are successively pierced by the bottom of the introversion container or the piercing nose of the bottom of the introversion container for the blending of the contents in accordance with the invention. By mechanical pressure onto the bottom of the introversion container the bottom or the piercing nose on the bottom's internal side is thereby pushed in the direction of the sealing foils, which are ruptured due to the pressure. Herein, first the sealing foil of the introversion container and then the sealing foil of the withdrawal container or if present the sealing foil of the intermediate container is pushed through. Due to the resulting openings the contents of the component containers come into contact with each other, the liquids are mixed with each other or a solid sited in the withdrawal container is dissolved in the liquid that was contained in the introversion container. The pressure, which causes a piercing or rupture of the sealing foils and therewith an influx or running over of liquid from the introversion container into the withdrawal container, is generated by the mechanical pressure exerted onto the bottom of the introversion container (FIG. 3).

The farther the introversion container is invaginated the higher the pressure becomes inside the multi-chamber mixing container. This elevated pressure can be decreased by withdrawing the obtained solution either with a needle or also in a needle-free manner via the withdrawal area of the withdrawal container. In case of a withdrawal with a needle or cannula, the obtained solution is preferably drawn into a syringe or a volume measuring device. In case of a withdrawal of the obtained solution in a needle-free manner, a transfer of the solution takes place for example into a dropping funnel or drip bag, in which also another liquid can already be present. If, however, the prepared solution shall not be withdrawn yet, the resulting pressure can also be released via a needle, cannula or a pressure relief valve located at the withdrawal container.

The inventive introversion container is a component container for the uptake of a liquid that is sealed at the front side with a pierceable sealing foil and its bottom can be pushed in the direction of the sealing foil and the wall is introversible to the inside. Preferably, the introversion container is filled completely, i.e. without gas inclusion on top of the liquid.

The introversion container is characterized in its outer shape by bottom, wall and front side. The term of the introversion capability is defined by the change of a shape. The introversible wall is herein pushed together with the bottom of the introversion container to the inside, so that preferably the internal side of the introverted wall glides along the internal side of the not yet introverted wall and the introversion container loses height during the introversion process (FIG. 4). If the multi-chamber mixing container consists only of one introversion container and one withdrawal container, the internal side of the wall of the introversion container can be in contact with the internal side of the wall of the withdrawal container in case of a complete introversion of the introversion container. If introversion container and withdrawal container have an identical height, the introversion container can be introverted completely into the withdrawal container and the bottom of the introversion container lies on or close to the withdrawal area of the withdrawal container (FIG. 3).

The introversion container according to aspects of the invention is thus characterized by the fact, that upon an adequate action of a force onto its bottom the wall is pushed to the inside. In other words, the introversion can also be described as plastic deformation of the inventive introversion container caused by impression. The introversible wall is advantageous, because in this way a change in the shape by impression of the introversion container into the withdrawal container or into the intermediate container(s) and the withdrawal container is caused. The external pressure means mechanical pushing preferably onto the center of the bottom of the introversion container.

Thus, the wall of the introversion container is introversible according to the present invention at least up to the point until the sealing foil of the withdrawal container is pushed through. In case of a multi-chamber mixing container made of introversion container and withdrawal container, the introversion container can preferably be introverted up to the connection plane of both component containers, as long as the withdrawal container has the same or a larger height than the introversion container. If, in addition, an intermediate container is sited between introversion container and withdrawal container, the single component containers can have identical or different heights. If all three component containers have the same height, then it is preferred that an introversion can occur up to the half height of the intermediate container, so that the introversion container can be completely introverted into the withdrawal container and the intermediate container can be introverted up to 50% into itself. If, instead, withdrawal container and intermediate container together have the same height as the introversion container, just the introversion container has to be designed to be introversible in order that the introversion container can be introverted completely into the withdrawal container as well as the intermediate container. If, instead, the withdrawal container has the same height as introversion container and intermediate container together, introversion container and intermediate container should be designed to be introversible in order that introversion container as well as intermediate container can be introverted into the withdrawal container. Of course, also any other heights of the component containers are possible. However, an introversion or invagination to a large extend should preferably be possible, wherein the multi-chamber mixing container loses ca. 50% of its height after complete introversion or invagination.

Accordingly, if the multi-chamber mixing container consists of an introversion container, a withdrawal container and two intermediate containers, again different heights of the component containers are also possible. If all four component container have the same height, then it is preferred, if the introversion container and the first intermediate container adjacent to the introversion container are introversible, so that upon complete introversion or invagination the internal side of the wall of the introversion container is in contact with the internal side of the wall of the withdrawal container and the internal side of the wall of the first intermediate container is in contact with the internal side of the wall of the second intermediate container. If, instead, withdrawal container, first intermediate container and second intermediate container together have the same height as the introversion container, just the introversion container has to be designed to be introversible in order that it can be introverted into the withdrawal container and the two intermediate containers. If, instead, introversion container and the two intermediate containers together have the same height as the withdrawal container, then it is preferred, if introversion container and both intermediate containers are designed to be introversible in order that these three component containers can be introverted into the withdrawal container. It is evident for a person skilled in the art that the four component containers can also have other arbitrary heights and an introversion capability preferably from the bottom up to the middle of the multi-chamber mixing container shall be given in order that the lower part of the multi-chamber mixing container can be introverted into the upper part of the multi-chamber mixing container.

Consequently, it can be necessary to design a component container in such a way that not its entire wall but only the wall up to a certain height is introversible.

The introversion capability is primarily defined by the nature of the material. Here, extra solid materials stand for no or minor introversion capability, so that a nature of the material is preferred that enables an easy impression and/or inversion without the material being damaged or a too high effort being necessary. However, the material must not be that soft, that the shape of the liquid-containing introversion container is not stable or that a mechanical damage of the introversion container is possible. The container can be composed of any material that is suitable for the storage of a liquid. Herein preferred materials are metal, a metal alloy, rubber, or any liquid-impermeable polymer, wherein polymers and rubber are more preferred, and especially preferred polymers and most notably plastic. Here, different rigidities of the synthetic material can influence the introversion capability. Thus, soft plastic, so especially flexible synthetic material such as for example soft-PVC or polyolefins, e.g. polyethylene, is especially preferred for the manufacture of the introversible part, and hard plastic is preferred for that part that shall not be introverted. The impression or the invagination can herein be supported but also limited by so-called notch lines. The notch lines, which shall limit the introversion capability, further comprise a transition to a stronger nature of the material that prevent a further easy invagination, so especially by a transition from soft plastic to hard plastic. Preferably, however, the notch lines are designed for the support of the introversion capability and represent for example thinnings in the wall, so that an inversion or introversion of the wall along the notch lines is facilitated. Preferably, in this way a section of the wall can be invaginated up to the next notch line more easily, so that the notch lines function like the movable junctions of a chain in a track vehicle and always one link of the chain can be introverted to the inside up to the next notch line more easily. Here, it is preferred, if the notch lines run around the wall in a closed circle. It is moreover preferred, if the notch lines run with same distance to each other.

The volume of the inventive introversion container but also the volume of additional inventive component containers is preferably between 0.5 and 20 ml, even more preferably between 1 and 20 ml, more preferably between 2 and 18 ml, even more preferably between 3 and 16 ml, even more preferably between 4 and 15 ml, even more preferably between 4 and 14 ml, even more preferably between 5 and 13 ml, even more preferably between 5 and 12 ml and even more preferably between 5 and 11 ml. The shape of the introversion container is preferably cylindrical, wherein the wall is preferably round, the bottom is preferably concave, so curved to the inside, and the front side is flat. Here, the bottom of the introversion container can be adapted to the shape of an expression plunger of a device for the reception of a multi-chamber mixing container. This expression plunger preferably has a flat conical tip, which for example engages with a corresponding cut-out of the bottom of the introversion container or is in contact with a correspondently designed bottom of the introversion container. This adaptation of the outer shape of the bottom or at least of a central area of the bottom of the introversion container to the shape of the tip of the expression plunger is advantageous, because thereby a sliding off of the expression plunger can be avoided and an efficient mechanical force transmission can be ensured. In an additional preferred embodiment the bottom of the introversion container is designed flat at the outside. Here, the tip of the expression plunger presses into the bottom so that thereby a sliding off of the expression plunger is avoided.

The material of the bottom of the introversion container has preferably a higher rigidity than the introversible, soft material of the wall, thus, it is preferably made of hard plastic. This material reinforcement is advantageous in order that due to the pressure exerted onto the bottom by the expression plunger the bottom is not damaged or even ruptures.

The surface of the bottom being located in the interior of the introversion container can have a design that facilitates the piercing of the sealing foils. According to aspects of the invention the bottom of the introversion container can have a piercing nose or protrusion or bulge formed in the direction of the sealing foil and positioned centrally or the bottom can be shaped concave such as for example in the case of a champagne bottle. This piercing nose, protrusion, bulge or concave design of the bottom can be made of a harder material and/or be formed adequately sharp in order to facilitate a pushing through of the sealing foils.

This piercing nose or bottom design can be moved axially by external pressure onto the introversion side, so especially by eversion of the wall. The piercing nose or the bottom design serves to push through the front-end sealing foil of the introversion container. Furthermore, the piercing nose or the bottom design serves to push through the sealing foil of an attached component container or the sealing foils of attached component containers. If the component containers are completely filled with liquids, the piercing nose is preferably located close to the sealing foils to be pierced, in order that already after a small pressure application a pushing through of the sealing foil takes place, so that the liquids can mix. If the piercing nose is not located in close vicinity to the sealing foils to be pierced, the piercing nose can be designed also flexible in such a way that it can be impressed to such an extent upon pressure onto the middle of the bottom of the introversion container that the sealing foils are pushed through and it afterwards moves back flexibly to its initial position and only afterwards the impression of the entire bottom takes place for the purpose of emptying of the multi-chamber mixing container. In the case that component containers are filled with a liquid, it is preferred, if these are filled completely, so without inclusion of gases such as air or inert gases such as nitrogen or argon. A complete filling of a component container furnished with a sealing foil can be achieved by welding the sealing foil with the completely filled component container e.g. with a laser after complete filling without an input of gas resulting at the same time. In case that a component container is filled with a solid or a paste or a gel or not completely with a liquid, a further preferred embodiment is, that the sealing foil is permeable to gases but impermeable to liquids or solids. In such a case, an occurring pressure due to the compression of a gas inside the component container can be reduced through the sealing foil in a way that the gas passes the sealing foil as long as it is still intact, i.e. not yet pushed through or ruptured. If, additionally, a cannula is located in the withdrawal area of the withdrawal container, the gas can escape via the cannula and thereby the pressure inside the multi-chamber mixing container can be reduced. In the case that a cannula shall not or not yet be introduced for reduction of the pressure inside the withdrawal area of the withdrawal container, also the septum, which seals the withdrawal area of the withdrawal container, can be permeable to gases but impermeable to liquids, solids or cells. In such a case, the pressure inside the multi-chamber mixing container can then be reached by escape of gas through the septum in the withdrawal area of the withdrawal container. It goes without saying that in such a case the withdrawal area of the withdrawal container has to be held upwards just like with a filled syringe, so that the risen gases can escape. Instead of a gas-permeable septum also a valve can be used.

An additional alternative is the piercing of the sealing foil by a cannula introduced via the withdrawal area of the intermediate container, wherein after the puncture the cannula is retracted, the solutions are mixed and afterwards the multi-chamber mixing container is emptied by impression of the bottom and introversion of the introversion container. If a solid is filled into the intermediate container or the withdrawal container, it is preferred that it is sited in the component container under reduced pressure or under vacuum. In such an embodiment, the pressure resulting inside the introversion container from the impression of the bottom suffices in most cases to severe the sealing foils before the bottom of the introversion container or the piercing nose reach the sealing foils. The piercing nose is preferably made of the same material as the introversion container, especially if the introversion container is furnished with notch lines, or of a hard material, which can withstand the acting forces. A hard material of the piercing nose or the bottom design is advantageous, because in this way a sufficient stability for the pushing through of one or several sealing foil(s) is ensured. Here, a particularly preferred material for the piercing nose is hard plastic. The length of the piercing nose or bottom design is here at least that long that upon invagination of the bottom or the wall it pushes through the sealing foil of the front side and the sealing foil of the adjacent withdrawal container. Furthermore, it can be that long that it crosses the introversion container in its entire length. This embodiment is advantageous and thus preferred, because it is especially suited to push through several sealings, if several component containers are arranged consecutively as for example in the tri-system or quad-system.

The piercing nose or the protrusion or the bulge or the concavely shaped bottom of the introversion side of the introversion container can have canals, furrows, corrugations, star-shaped indentations, mounds, knobs, pins or other surface irregularities, that enable a rapid influx or running over of the liquid from the introversion container into at least one additional component container. Herein, the liquid preferably flows from the introversion container into the at least one additional component container. This makes particularly sense, if a solid is sited in the at least one additional component container. The flux of the liquid is enabled in particular by the axial movement of the inner device. However, if the withdrawal container contains a liquid, it is also possible that the liquid from one of the additional component containers flows in the direction of the introversion container and that the liquids mix in this way. The rapid running over of liquid enabled by the provided canals etc. is advantageous in order to ensure a rapid through-mixing of the liquids or of the solutions or suspensions of the solid in the liquid particularly upon a partial or complete invagination of the introversion container into the component container attached to the front side.

The round shape of the wall is particularly advantageous and particularly preferred, because it enables the introversion capability best. However, the wall can also be divided by edges into several subareas. Here it is preferred, if the sidewall is divided into at least eight subareas, since a smaller number of subareas impedes the introversion. The smaller the internal angle between the edges the more difficult is the introversion process. If the component containers are not designed round but angular, i.e. if the cross sectional area is not circular but angular, then the internal angle between the edges shall be at least 135°. However, a circular cross section of the component containers and, thus, a cylindrical shape of the multi-chamber mixing container are most preferred, wherein an oval shape is also preferred.

The front side of the introversion container is the side opposite to the bottom. The front side is sealed with a sealing foil. The introversion container is filled with the liquid with the bottom downwards and is afterwards sealed with the sealing foil. The sealing foil is pierceable, that means that the piercing, pushing through or rupturing of the sealing foil by the action of a force is possible. When the sealing foil of the introversion container and of the adjacent component container is severed the liquid can flow from the introversion container into the adjacent component container.

The sealing of the introversion container by a sealing foil serves for the sterile and firmly bonded closure of the container. The sealing foils serves for the sealing of the introversion container or in the most general sense of the component containers, which were filled under aseptic conditions, so that the content of each component container remains sterile and germ-free. The sealing foil for the closure of the component container can for example be present as composite film. Preferred materials are for example metals such as for example aluminium foil, furthermore synthetic materials, compositions of metal and synthetic material, polymers or combinations thereof. In a preferred embodiment the sealing is carried out as “weak seal”, i.e. at one or several sites the material of the sealing foil is particularly weak, so that it can be pierced more easily, or pre-press cuts are introduced, so that the material ruptures more easily at these sites. However, it is important that the sealing foil seals the device completely and air-tight in order to ensure a sterile storage of the contents and that it also does not rupture in case of chilled storage due to the contraction of the material at coldness up to preferably 0° C., more preferred −15° C. and especially preferred −25° C. A person skilled in the art is aware of enough materials and options to realize such a sealing foil. Preferred materials are for example metals such as for example aluminium foil, furthermore synthetic materials, compositions of metal and synthetic material, polymers or combinations thereof.

In a preferred embodiment, the introversion container has a groove at the outer face of the wall or a recess in the outer face of the wall. This groove or recess is advantageous, because in a device for the reception of the introversion container, which has a counterpart to it, so a corresponding projection or an attachment or a trunnion, it prevents a twisting of the inserted introversion container and guarantees a stable position This groove or recess is preferably located at the level of the front side or along the contact surface or contact lines of two component containers. This design is advantageous in order not to inhibit the invagination of the wall. However, it can be similarly desired that the groove or recess limits or stops the invagination at a certain position. The arrangement of the groove or recess at a different height of the wall is thus preferred as well. The shape of the groove or recess is herein elongated and preferably round, however edged shapes are also possible. It is also possible and preferred, if the introversion container has instead of the groove or recess has a projection or an attachment or a trunnion and the said device for the reception of the introversion container has a corresponding relief. This inventive device for the reception of the multi-chamber mixing container is described in more detail further below and comprising a receptacle in the shape of a half-shell for the multi-chamber mixing container, mounting means for the multi-chamber mixing container and an expression plunger movable in axial direction.

The inventive introversion container preferably has in addition a joining edge. This joining edge is advantageous, because it enables a slip-proof joining with other containers and mediates a mechanical support to the combination. Here, the joining edge is fixed at the front side of the introversion container. Herein, the joining edge ideally is composed of the same material as the introversion container, in fact as the non-introversible part of the introversion container, if such a part is existent. For a more efficient joining of two containers it is advantageous, if the joining edge of one container has a groove and the other a tongue fitting thereto. It is also possible that the joining edges have screwing options corresponding to each other. Furthermore, the joining edge can preferably have at the external side said groove, recess, projection or trunnion, which shall prevent a twisting or slipping out of position in a device for the reception of the introversion container.

The withdrawal container according to aspects of the invention is characterized in its outer shape by front side (top side), wall and bottom side. Like the front side (top side) of the introversion container, the top side of the withdrawal container is sealed by a pierceable sealing foil, so that the content of the withdrawal container remains sterile. For the material and the design of the sealing foil the same preferred criteria are valid than for the sealing foil of the introversion container. Herein, the withdrawal container can contain a liquid, a solution or a solid substance or a mixture of solids. Solid substances are preferably in powder form, further preferably lyophilized or freeze-dried. Herein, the shape of the withdrawal container is preferably adapted to that of the introversion container, i.e. the diameter and the shape of the bottom side corresponds to that of the introversion container, whereby a tight, thus firmly bonded connection can be ensured. Hence, it is important that front side of the introversion container and bottom side of the withdrawal container in the bi-system (so without intermediate containers) fit well to each other, i.e. preferably shall have the same diameter and preferably shall also have the same wall thickness.

The material of the withdrawal container preferably has a rigid nature and is herein preferable designed as the non-introversible part of the introversion container, if such a part is existent. It is not necessary that the withdrawal container is introversible, on the contrary, the withdrawal container should be non-introversible and the wall of the withdrawal container should withstand the pressure exerted by the expression plunger and not be deformed. Hence, the withdrawal container is preferably made of metal or a polymer, more preferred of plastic, and especially preferred of hard plastic.

Furthermore, it is advantageous, if also the wall of the withdrawal container has the same shape than that of the introversion container, so that both containers fit into the same device for the reception of the multi-chamber mixing container. Furthermore, the same shape is advantageous, because thereby the introversion container can be introverted into the withdrawal container without gaps or mechanical obstruction (FIG. 4). It is therefore advantageous, if the withdrawal container resembles the mirror-inverted shape of the introversion container. Thus, the withdrawal container preferably has the same volume and the same length than the introversion container. However, it is also possible that the withdrawal container has larger or smaller volumes and lengths than the introversion container, wherein the diameter of both component containers should be identical or different from each other by maximally 10%.

Like the introversion container, the withdrawal container also has a groove, a recess, projection or a trunnion, which shall prevent a twisting or slipping out of positioning in a device for the reception of the multi-chamber mixing container. Herein, it is especially preferred, if the grooves, recesses, projections or trunnions are positioned along the assembly seams of the joined containers.

The withdrawal container has in addition a withdrawal area and preferably has an area at the bottom side of the withdrawal container that can be punctured by a needle. The withdrawal area seals the withdrawal container hermetically, so that the content remains sterile and germ-free, but still the freshly prepared solution can be withdrawn through the withdrawal area. An area that can be punctured by a needle such as for example a plug or a septum is preferred, so that with a needle or a cannula the solution can be withdrawn and drawn into a syringe or transferred into a container or bag. The plug advantageously can be crimped with the container in a form-fit manner by a metal crimp cap, so an external closure preferably from aluminium sheet. Possible as closure systems of this type are so called tip caps. For an optimal form closure in connection with the crimping the area exceeding the plug is ideally furnished with a funnel-shaped undercut, so with an edge around which the crimp cap can be crimped. In general, also the possibility exists to insert and weld the plug from the internal side of the container, whereby a crimp cap could be omitted. In order to keep the contact surface of the content with the plug or septum as small as possible, the alternative with the crimp cap is more advantageous and therefore preferred.

Furthermore, a needle-free access to the withdrawal container is possible and preferred. In case of a needle-free access a polymer tube with a diaphragm valve is placed through the plug into the withdrawal container. Conceivable are needle-free accesses like they are known from infusion therapy, e.g. in the so called drip. The needle-free access enables a safe and convenient withdrawal of the mixed content of the connected containers from the withdrawal container. Herein, the content is conducted into a collection container such as for example a drip bag. Here, the withdrawal container with the needle-free access and the collection container forms a closed, sterile system.

In addition, it is preferred, if the withdrawal container has a pressure-controlled exhaust valve or pressure relief valve for the escape of excessive air.

In an additional preferred embodiment the inventive multi-chamber mixing container consists of an introversion container and a withdrawal container and an intermediate container filled with a liquid or a solid and located in between introversion container and withdrawal container (FIG. 5), wherein the intermediate container is sealed on the top side and on the bottom side with a pierceable sealing foil and the intermediate container is connected with the introversion container in a sealing manner and with the withdrawal container in a sealing manner. In this embodiment, the multi-chamber mixing container is a tri-system (FIG. 6).

So the intermediate container is a further component container that provides a third component for mixing. The intermediate container further comprises a wall and a top side as well as a bottom side. Both top side and bottom side are each sealed by a pierceable sealing foil. For the material of the sealing foil the preferred criteria are valid that were mentioned for introversion- and withdrawal container. Thus, in the multi-chamber mixing container in total four sealing foils (front side of the introversion container, top- and bottom side of the intermediate container, bottom side of the withdrawal container) have to be pushed through in order to enable contact and mixing of all components.

Herein, the shape of the intermediate container is preferably adapted to that of the other component containers, i.e. corresponds to them in diameter and shape, whereby a tight, so closely sealed connection with the other component containers can be ensured.

Here, the volume of the intermediate container can have any desired size, preferably, however, corresponding to that of the other component containers. More preferred, however, the volume of the intermediate container is smaller than that of the introversion container or withdrawal container. Basically, however, there is no limitation in the volume of the component containers. Since all component containers should substantially have the same diameter, the volume of the respective component container is thus determined by its height. Since it is furthermore preferred that only the introversion container is designed to be introversible and withdrawal container as well as intermediate containers are not introversible but substantially dimensionally stable, the height of the introversion container should approximately correspond to the total height of withdrawal container and all intermediate containers, so that the introversion container can be completely introverted into the intermediate container(s) and the withdrawal container.

The material of the wall of the intermediate container preferably has a rigid nature and is herein preferable designed as the withdrawal container. Hence, the wall of the intermediate container is preferably made of metal or a polymer, more preferred of plastic, and especially preferred of hard plastic.

However, in an additional preferred embodiment the wall of the intermediate container can also be composed of soft plastic, so especially flexible synthetic material such as for example soft-PVC or polyolefins, e.g. polyethylene. Due to this material an introversion capability is achieved. This introversion capability is advantageous, because it enables an introversion exceeding the invagination of the introversion container. This can for example be necessary, if the intermediate container is too large to enable a piercing of the lower sealing foil of the intermediate container and of the attached withdrawal container by the piercing piston of the introversion container. Thus, the intermediate container shall always be at least partially or also completely introversible in cases, when the height of the withdrawal container plus the height of the intermediate container is larger than the height of the introversion container. If the height of the withdrawal container is as large as the height of the intermediate container plus the height of the introversion container, then the intermediate container should also be introversible over its entire height in order that intermediate container and introversion container can be completely introverted into the withdrawal container.

A preferred embodiment of the present invention is therefore related to a multi-chamber mixing container consisting of an introversion container and a withdrawal container and an intermediate container filled with a liquid or a solid, the intermediate container is located in between introversion container and withdrawal container, wherein the intermediate container is sealed on the top side and on the bottom side with a pierceable sealing foil and the intermediate container is connected with the introversion container in a sealing manner and with the withdrawal container in a sealing manner.

Preferably in the multi-chamber mixing container the introversion container, the intermediate container and the withdrawal container have a groove, a bead, a thread or a recess at the level of the sealing foil for the sealing connection between introversion container and intermediate container and between intermediate container and withdrawal container.

According to aspects of the invention, the outer shape of the component containers is cylindrical with congruent or largely congruent outer radii. In this multi-chamber mixing container made of three component containers a liquid is sited in the introversion container and a liquid or a solid is sited in the intermediate container as well as a liquid or a solid is sited in the withdrawal container. A suchlike multi-chamber mixing container can also be assembled by the physician or the hospital staff themselves from the single component containers of a kit, herein disclosed, whereby a high flexibility in regard to the choice and quantity of the solvent as well as to the choice, quantity and concentration of the active agents exists.

In an additional preferred embodiment the inventive multi-chamber mixing container consists of the introversion container and the withdrawal container and two intermediate containers each filled with a liquid or a solid and located in between introversion container and withdrawal container, wherein both intermediate containers are sealed on the top side and on the bottom side with a pierceable sealing foil and both intermediate containers are connected with each other in a sealing manner and the first intermediate container is connected with the introversion container in a sealing manner and the other intermediate container is connected with the withdrawal container in a sealing manner. In this embodiment the multi-chamber mixing container is a quad-system.

Thus, an aspect of the present invention is also directed to multi-chamber mixing containers, which consist of an introversion container and a withdrawal container and two intermediate containers each filled with a liquid or a solid and located in between introversion container and withdrawal container, wherein both intermediate containers are sealed on the top side and on the bottom side with a pierceable sealing foil and both intermediate containers are connected with each other in a sealing manner and the first intermediate container, is connected with the introversion container in a sealing manner and the other intermediate container is connected with the withdrawal container in a sealing manner.

Herein, multi-chamber mixing containers are preferred, wherein for the sealing connection between introversion container and the first intermediate container and between the first and the other intermediate container and between the other intermediate container and the withdrawal container, the introversion container, the first intermediate container, the other intermediate container and the withdrawal container have a groove, a bead, a thread or a recess at the level of the sealing foil. Preferred are furthermore multi-chamber mixing containers, wherein the multi-chamber mixing container consisting of introversion container and withdrawal container has on the outside along the connecting line between introversion container and withdrawal container a groove or the multi-chamber mixing container consisting of introversion container, intermediate container and withdrawal container has on the outside along the connecting line between introversion container and intermediate container and/or between intermediate container and withdrawal container a groove or the multi-chamber mixing container consisting of introversion container, two intermediate containers and withdrawal container has on the outside along the connecting line between introversion container and the first intermediate container and/or between the both intermediate containers and/or between the other intermediate container and withdrawal container a groove. This groove serves on the one side for the sealing connection of the component containers with each other as well as for the fixation of the multi-chamber mixing container in the device for the reception of the multi-chamber mixing container. Another preferred way for the sealing connection of the component containers with each other is via a thread, wherein a smooth outer jacket without grooves results, so a smooth cylinder that can be inserted in a corresponding tubular device in order to empty therein the multi-chamber mixing container as usual by pressure onto the bottom of the introversion container.

So the second intermediate container is a further component container in addition to the (first) intermediate container described above, which provides a fourth component for mixing. The second intermediate container further comprises a wall and two sides sealed by a sealing foil. For the material of the sealing foil the preferred criteria are valid that were mentioned for introversion-, withdrawal- and first intermediate container. Thus, in the multi-chamber mixing container in total six sealing foils (front side of the introversion container, top- and bottom side of the first intermediate container, top- and bottom side of the second intermediate container, top side of the withdrawal container) have to be pushed through in order to enable contact and mixing of all components.

However, it is also possible and preferred that the four component containers are connected to each other in such a way that in each case only one sealing foils is sited between the respective components. Then, only three sealing foils would have to be pushed through in order to ensure contact and mixing of the components.

Herein, the shape of the second intermediate container is preferably adapted to that of the other component containers, i.e. corresponds to them in diameter and shape, whereby a tight, thus closely sealed connection can be ensured.

Here, for the volume and the size of the second intermediate container the same criteria than for the first intermediate container are valid. Herein, the intermediate containers can have the same size, but can also be differently large. The same is valid for the material of the wall of the second intermediate container. Also the second intermediate container can be introversible, however, preferably it is not. However, it is especially preferred, if only one out of two intermediate containers is introversible. If one intermediate container is introversible, it is the intermediate container connected to the introversion container.

In additional possible preferred embodiments also more than two intermediate containers can be contained in the multi-chamber mixing system. In this case, one would speak of a multi-system. Herein, it is preferred; if at least one intermediate container is introversible.

Like withdrawal container and introversion container, the intermediate container(s) preferably have a groove, recess, projection or a trunnion, which shall prevent a twisting or slipping out of positioning in a device for the reception of the multi-chamber mixing container. Herein, it is especially preferred, if in the joined component containers the grooves, recesses, projections or trunnions are positioned along the contact surfaces of the component containers.

Thus, the inventive multi-chamber mixing container has several grooves, recesses, projections or trunnions that can be arranged in one line and fit together with corresponding trunnions, projections, recesses or grooves of a device for the reception of the multi-chamber mixing container, whereby the multi-chamber mixing container can be mounted in the device in a slip- or torque-proof manner.

All intermediate containers can preferably have a joining edge. All intermediate containers have further preferably a groove or recess or also a trunnion or a projection at the top side and/or at the bottom side, so in the connection plane of the component containers.

A device for the reception of the multi-chamber mixing container in order to conduct the introversion and thereby freshly preparing the desired solution additionally belongs to the invention. This device comprising a receptacle in the shape of a half-shell for the multi-chamber mixing container, mounting means for the multi-chamber mixing container and an expression plunger movable in axial direction. The device preferably is a carpule-like system, which is used for the mixing of the substances of content of the component containers (FIG. 4). The device is carried out as receptacle in the shape of a half-shell with one or several centering grooves, recesses, trunnions or projections as mounting means in the connection plane of the containers, which centers the multi-chamber mixing container and keeps it in its position. The device is characterized in that it can take up the multi-chamber mixing container, stabilize it in its position by the mounting means and additionally has an expression plunger movable in axial direction for the application of external pressure onto the bottom of the introversion container.

The expression plunger movable in axial direction preferably has a centering tip that fits into the provided cut-out in the bottom of the introversion container. The centering tip is advantageous, because it enables an efficient force transmission from expression plunger to the bottom of the introversion container and prevents a sliding off of the expression plunger. The expression plunger preferably has in addition a stop ring in order to limit an undesired large impression into the device.

The device for a tri-, quad- or multi-system is in principle constructed similarly, solely length of the device and number of the centering grooves are adapted to the respective configuration of the multi-chamber mixing container.

Furthermore, a method for the aseptic preparation of a solution from at least two components belongs to the invention, further comprising the insertion of a multi-chamber mixing container in the device for the reception of the multi-chamber mixing container, exertion of pressure by the expression plunger to the bottom of the introversion container, pushing the bottom of the introversion container in the direction of the withdrawal container, whereat the wall of the introversion container is continuously introverting to the inside and with onward pushing the sealing foils are pierced and mixing of the at least two components.

After the preparation of the solution under aseptic conditions the withdrawal of the prepared solution takes place through the withdrawal area of the withdrawal container with a needle or also in a needle-free manner as delineated above.

Miscible components for preferably parenteral applications, which can be stored in the multi-chamber mixing container preferably as solid and can be mixed short before the application with the solvent stored separately in the multi-chamber mixing container, are for example antibiotics, analgesics, anti-inflammatory active agents, steroids, antiproliferative, immunosuppressive, fungicidal, cytostatic, antimigratory, antiphlogistic, cytotoxic, anti-angiogenic and/or antithrombotic active agents, vitamins, carotenoids, pain killers, or amino acids, or other active agents. Liquids for the dissolution or mixture comprise double-distilled water, isotonic sodium chloride solution or various other isotonic saline solutions.

In the following the present invention is elucidated by two examples, which disclose specific embodiments but which shall not be limiting in regard of the scope of protection of the invention. Consequently, variations and modifications of the invention obvious for a person skilled in the art are falling under the scope of protection of the patent claims.

### DESCRIPTION OF THE DRAWINGS

The invention is best understood from the following detailed description when read in connection with the accompanying drawings. Included in the drawings are the following figures:

FIG. 1

FIG. 1 shows an introversion container (5) as component container, which is filled with a liquid (3) ca. up to 50%. The front side or top side (9) of the introversion container (5) is sealed with a sealing foil (1), so that the content of the introversion container (5) remains aseptic, sterile and germ-free. Along the rim of the top side (9) of the introversion container (5) runs a bead or groove (7), which is advantageous for the sealing and/or firmly bonded joining of the component containers and also serves as means for fastening in the device (30) for the reception of the multi-chamber mixing container (20). The sealing foil (1) is designed in such a way, that it can be pushed through by the piercing nose (4) or protrusion (4) or bulge (4). The piercing nose (4) or protrusion (4) or bulge (4) is located centrally on the bottom (8) of the introversion container (5). Moreover, the bottom (8) of the introversion container (5) is shaped cylindrically to the inside, so that a cut-out (6) or relief (6) for the reception of the expression plunger (32) results. The introversion container (5) additionally has a circumferential wall (2), which is composed of an elastic polymer. The wall (2) is additional furnished with circumferential notch lines (10) (not shown), so that an introversion of the wall (2) from one notch line (10) to the next is facilitated. The wall (2) of the introversion container (5) is designed in such a way, that by exertion of pressure onto the bottom (8) of the introversion container (5) in the direction of the sealing foil (1) or in the direction of the top side (9) the wall (2) everts at the bottom (8) of the introversion container (5) and is pushed to the inside, i.e. into the cut-out or relief (6), so that the bottom (8) of the introversion container (5) continuously moves in the direction of the sealing foil (1). When the bottom (8) of the introversion container (5) reaches the sealing foil (1), then the introversion container (5) is only half as high as at the beginning, because half of the outer wall is now on the inside.

FIG. 2

FIG. 2 shows a withdrawal container (16) as component container, which is filled ca. to one third with a solid (13) or a liquid (13). The top side (19) of the withdrawal container (16) is sealed with a sealing foil (11), so that the content of the withdrawal container (16) remains aseptic, sterile and germ-free. The sealing foil (11) is designed in such a way, that it can be pushed through by the pressure exerted onto the bottom (8) of the introversion container (5). Along the rim of the top side (19) of the withdrawal container (16) runs a bead or groove (17), which is advantageous for the sealing and/or firmly bonded joining of the component containers and also serves as means for fastening in the device (30) for the reception of the multi-chamber mixing container (20). The sealing foil (11) is designed in such a way, that it can be pushed through by the piercing nose (4) or protrusion (4) or bulge (4) of the introversion container (5). At the bottom side the withdrawal container (16) has a withdrawal area (18), through which the freshly prepared solution from the component of the introversion container (5) and the component of the withdrawal container (16) can be withdrawn with a needle or cannula or also in a needle-free manner. The withdrawal area (18) is located in the closure (15) or forms a part of the closure (15). The closure (15) can be a plug or a septum, which is for example fastened around the neck of the bottom side of the withdrawal container (16) with a crimp cap. But the plug or septum can also be glued or welded to the material of the withdrawal container (16). In this case, the crimp cap can be omitted. The plug or the septum can be punctured with a needle or cannula, so that the freshly prepared solution can be withdrawn from the multi-chamber mixing container (20). Inside the withdrawal container (16) below the plug or below the septum the withdrawal area (18) is located, namely there, where the tip of the needle or of the cannula ends. At the bottom of the withdrawal container (16) also an indentation (14) or a cut-out (14) can be situated. This indentation (14) or cut-out (14) serves for the reception of the piercing nose (4) or protrusion (4) or bulge (4) of the introversion container (5). The solution can also be withdrawn from the multi-chamber mixing container (20) in a needle-free manner, if the closure (15) is designed as a valve. In addition, the withdrawal container (16) has a circumferential wall (12), which is composed of a solid or rigid polymer. The withdrawal container (16) is designed in a non-introversible fashion. Therefore, the withdrawal container (16) is composed of a solid material, which can withstand the pressure on the bottom (8) of the introversion container (5) without being deformed.

FIG. 3

FIG. 3 shows a multi-chamber mixing container (20) consisting of an introversion container (5) and a withdrawal container (16), which are connected to each other in a sealing manner, inserted into a device (30) for the reception of the multi-chamber mixing container (20). The device (30) comprises a receptacle in the shape of a half-shell for the multi-chamber mixing container (20) as well as mounting means (35) for the multi-chamber mixing container (20) in order to fix it in its position and an expression plunger (32) movable in axial direction. The expression plunger (32) has at its back end a grip disc (31) and a bulge (33) or a ring (33) in order to limit the axial movement of the expression plunger (32). At the tip of the expression plunger (32) is the centering tip (34), which rests on the bottom (8) of the introversion container (5) in order to displace it in the direction of the withdrawal container (16) or in the direction of the withdrawal area (18) of the withdrawal container (16) and thereby to invaginate the introversion container (5) on and on.

FIG. 4 shows now the state, where the introversion container (5) has been invaginated completely into the withdrawal container (16) and the expression plunger (32) is impressed up to the bulge (33) or up to the ring (33). The centering tip (34) of the expression plunger (32) is advanced up to the withdrawal area (18) of the withdrawal container (16) and the wall (2) of the introversion container (5) is in contact with the wall (12) of the withdrawal container (16). The liquid (3), which has been inside the introversion container (5), was able to flow into the withdrawal container (16) and to dissolve the component (13) of the withdrawal container (16) after the piercing of the sealing foils (7 and 17). This freshly prepared solution was able to flow out continuously from the withdrawal area (18) and through the closure (15) of the withdrawal container (16) via a cannula (36) during the continuation of the pushing process. FIG. 3 shows the state, where the multi-chamber mixing container (20) is completely emptied. The expression plunger (32) can now be drawn out of the invaginated multi-chamber mixing container (20), the multi-chamber mixing container (20) can be taken out of the device (30) and be disposed of.

FIG. 4

FIG. 4 shows a multi-chamber mixing container (20) consisting of an introversion container (5) and a withdrawal container (16), which are connected to each other in a sealing manner, inserted into a device (30) for the reception of the multi-chamber mixing container (20). The device (30) comprises a receptacle in the shape of a half-shell for the multi-chamber mixing container (20) as well as mounting means (35) for the multi-chamber mixing container (20) in order to fix it in its position and an expression plunger (32) movable in the axial direction. The expression plunger (32) has at its back end a grip disc (31) and a bulge (33) or a ring (33) in order to limit the axial movement of the expression plunger (32). At the tip of the expression plunger (32) is the centering tip (34), which rests on the bottom (8) of the introversion container (5) in order to displace it in the direction of the withdrawal container (16) or in the direction of the withdrawal area (18) of the withdrawal container (16) and thereby to invaginate the introversion container (5) on and on. Moreover, FIG. 4 shows the state, where the introversion container (5) has been invaginated a little more than half of its height by exerting a pressure onto the grip disc (31) of the expression plunger (32), which is conveyed by the centering tip (34) of the expression plunger (32) to the bottom (8) of the introversion container (5) and as a consequence evenly shoves the bottom forwards in axial direction and thereby invaginates the introversion container (5). In order that the multi-chamber mixing container (20) does not slip out of position in the device (30) under this exertion of pressure, the grooves (7 and 17) connected (glued or welded) to each other rest in the mounting means (35), which is designed as cut-out. Furthermore, it can be recognized that the bottom (8) of the introversion container (5) has in central position a piercing nose (4) or protrusion (4) or bulge (4), which has already pierced the sealing foil (1) of the introversion container (5) as well as the sealing foil (11) of the withdrawal container (16), so that the liquid (3) from the introversion container (5) was able to pass over into the withdrawal container (16) in order to dissolve the component (13) of the withdrawal container (16). The solution being formed in this way can be withdrawn through or from the withdrawal area (18) of the withdrawal container (16) with a needle or cannula or also in a needle-free manner.

FIG. 5

FIG. 5 shows an intermediate container (29) as component container, which is filled ca. up to 50% with a solid (23) or a liquid (23). The top side (25) of the intermediate container (29) is sealed with a sealing foil (21), so that the content of the intermediate container (29) remains aseptic, sterile and germ-free. The sealing foil (21) is designed in such a way, that it can be pushed through by the pressure exerted onto the bottom (8) of the introversion container (5). Along the rim of the top side (25) of the intermediate container (29) runs a bead or groove (27), which is advantageous for the sealing and/or firmly bonded joining of the component containers and also serves as means for fastening in the device (30) for the reception of the multi-chamber mixing container (20). The bottom side (26) of the intermediate container (29) is sealed with a sealing foil (24), so that the content of the intermediate container (29) remains aseptic, sterile and germ-free. The sealing foil (24) is designed in such a way, that it can be pushed through by the pressure exerted onto the bottom (8) of the introversion container (5). Along the rim of the bottom side (26) of the intermediate container (29) runs a bead or groove (28), which is advantageous for the sealing and/or firmly bonded joining of the component containers and also serves as means for fastening in the device (30) for the reception of the multi-chamber mixing container (20). The sealing foils (21 and 24) are designed in such a way, that they can be pushed through by the pressure exerted onto the bottom (8) of the introversion container (5). The wall (22) of the intermediate container (29) can be designed rigid or introversible or in part rigid and in part introversible. If the intermediate container (29) shall not be capable to be introverted into the withdrawal container (16), then the wall (22) is made of a solid material, which can withstand the pressures on the bottom (8) of the introversion container (5) without being deformed. If, on the contrary, the intermediate container (29) shall be introversible into the withdrawal container (16), then the wall (22) of the intermediate container (29) is designed flexible and introversible and can also have notch lines. If the intermediate container (29) is designed introversible, it is preferably composed of the same material than the introversion container (5) and also has preferably the same kind and design of notch lines. If, on the contrary, the intermediate container (29) shall only be introversible in part, the wall (22) is designed introversible up to the height up to which the intermediate container (29) shall be introversible and beyond that the wall (22) is composed of a solid non-introversible material.

FIG. 6

FIG. 6 shows a multi-chamber mixing container (20) consisting of an introversion container (5), an intermediate container (29) and a withdrawal container (16), which are connected to each other aseptically and in a sealing manner. From above one has a look into the cut-out (6) or relief (6) for the reception of the expression plunger (32) of the device (30). The bottom (8) of the introversion container (5) has a piercing nose (4) or protrusion (4) or bulge (4), which points in the direction of the withdrawal container (16). The introversion container (5) is filled partially with a liquid (3). The wall (2) of the introversion container (5) has at the top side (9) a circumferential bead or groove (7), which is connected with the bead or groove (27) of the top side (25) of the intermediate container (29) in a tightly sealed manner. The sealing foil (1) of the introversion container (5) attached to the front side lies above the sealing foil (21) of the intermediate container (29). The intermediate container (29) is surrounded by the wall (22), which has an additional bead or groove (28) at the rim of the bottom side (26). Moreover, an additional sealing foil (24) is sited at the bottom side (26), whereby the content (23) of the intermediate container (29) is sealed germ-free and sterile. The bead or groove (28) is connected with the bead or groove (17) of the withdrawal container (16) in a sealing and firmly bonded manner. Below the sealing foil (24) of the intermediate container (29) the sealing foil (11) of the withdrawal container (16) is sited. The withdrawal container (16) is filled partially with a liquid (13) or a solid (13) and surrounded by the wall (12). At the bottom side the withdrawal container (16) has a closure (15) and a withdrawal area (18), through which or from which the freshly prepared solution from the component of the introversion container (5) and the component of the intermediate container (29) and the component of the withdrawal container (16) can be withdrawn with a needle or cannula or also in a needle-free manner. The multi-chamber mixing container (20) is constructed in such a way that the introversion container (5) has the same height as the intermediate container (29) and the withdrawal container (16) together, or it is even slightly larger, so that the introversion container (5) can be completely introverted into the intermediate container (29) and the withdrawal container (16).

FIG. 7

FIG. 7 shows a withdrawal container (16) of a multi-chamber mixing container (20) according to aspects of the invention with a thread for the sealing connection with an introversion container (5). The corresponding introversion container (5) is depicted in FIG. 8 in a filled and not introverted form and in FIG. 9 in an invaginated form.

FIG. 8

FIG. 8 shows an introversion container (5) in a filled and not introverted form with an internal thread for the form-fit and sealing connection with a withdrawal container (16) as shown in FIG. 7.

FIG. 9

FIG. 9 shows an introversion container (5) in a form emptied and introverted to a large extend with an internal thread for the form-fit and sealing connection with a withdrawal container (16) as shown in FIG. 7.

FIG. 10

FIG. 10 shows a multi-chamber mixing container (20) consisting of an introversion container (5) as shown in FIG. 8 and a withdrawal container (16) as shown in FIG. 7, connected in a sealing manner by a thread like in a ballpoint pen, so that a smooth outer jacket with a constant outer diameter results. In this embodiment no groove or bead is present and the multi-chamber mixing container (20) can be slided into a tubular device due to its cylindrical outer jacket, so that the withdrawal area of the withdrawal container (16) protrudes from the tubular device and the multi-chamber mixing container (20) can be emptied with an expression plunger (32).

FIG. 11

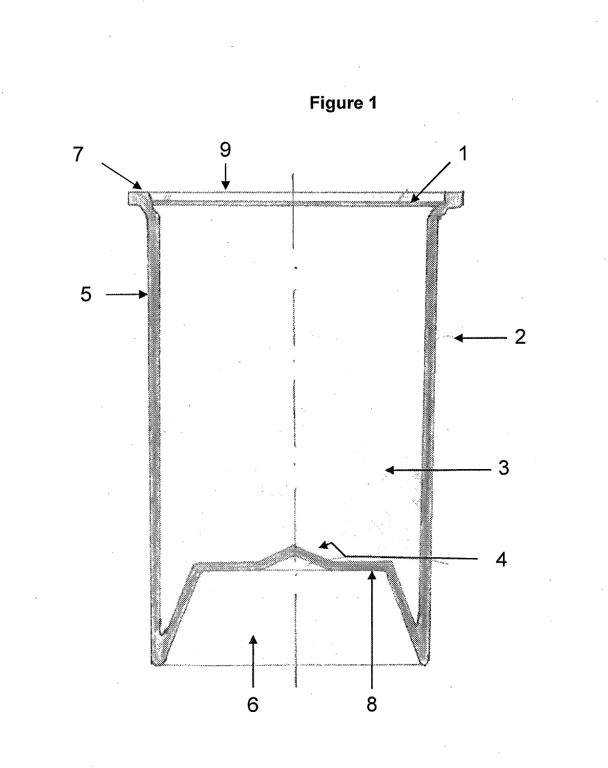

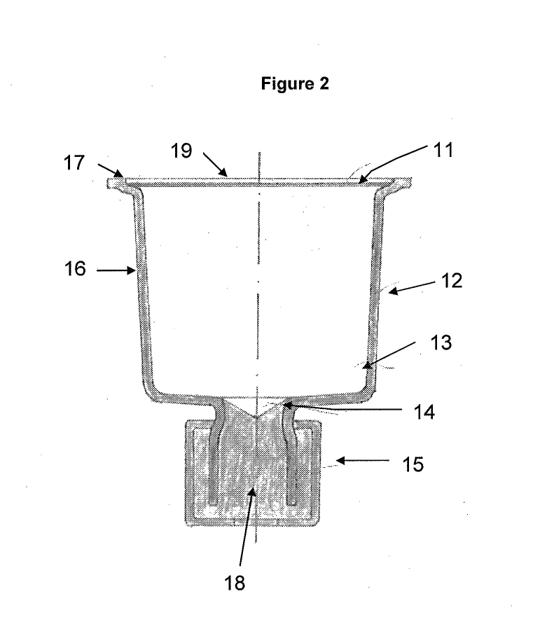

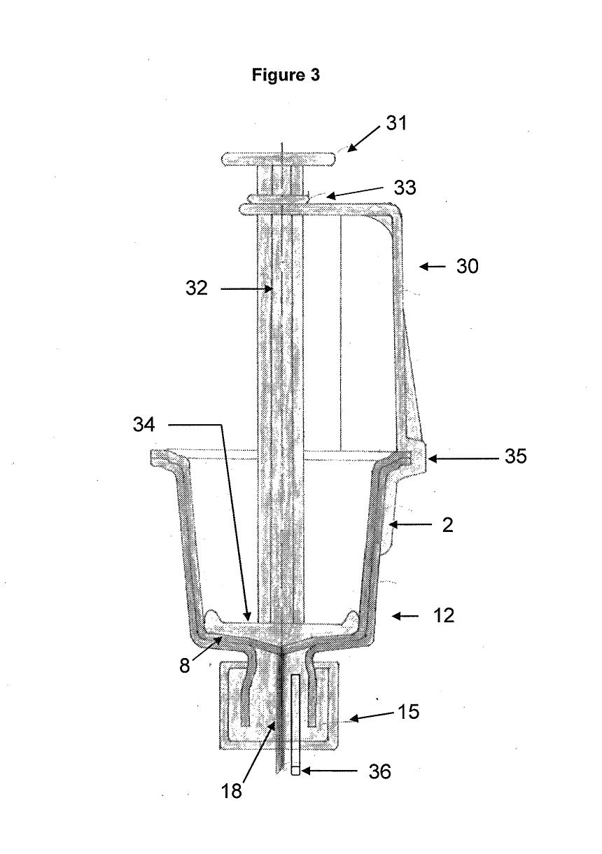

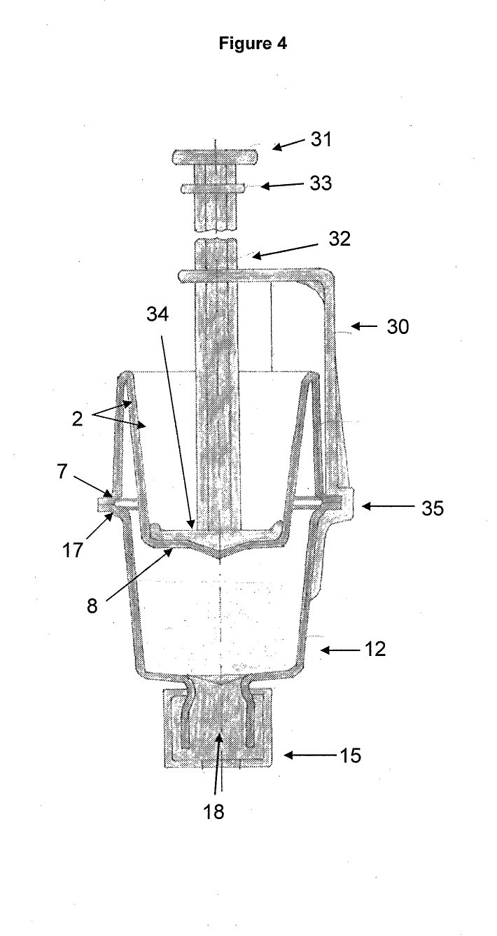

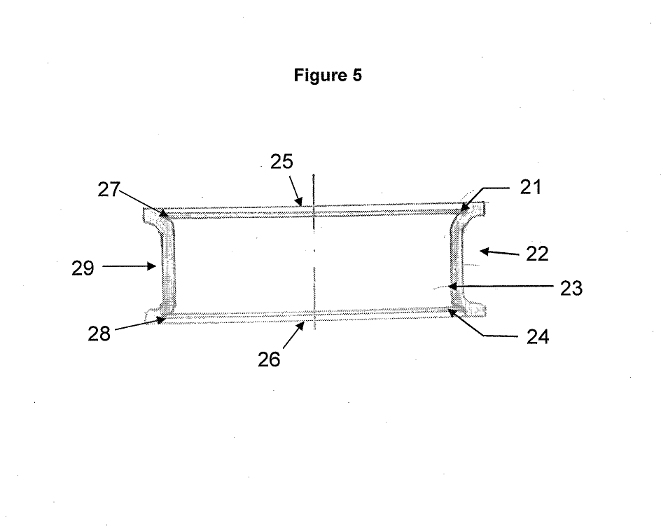

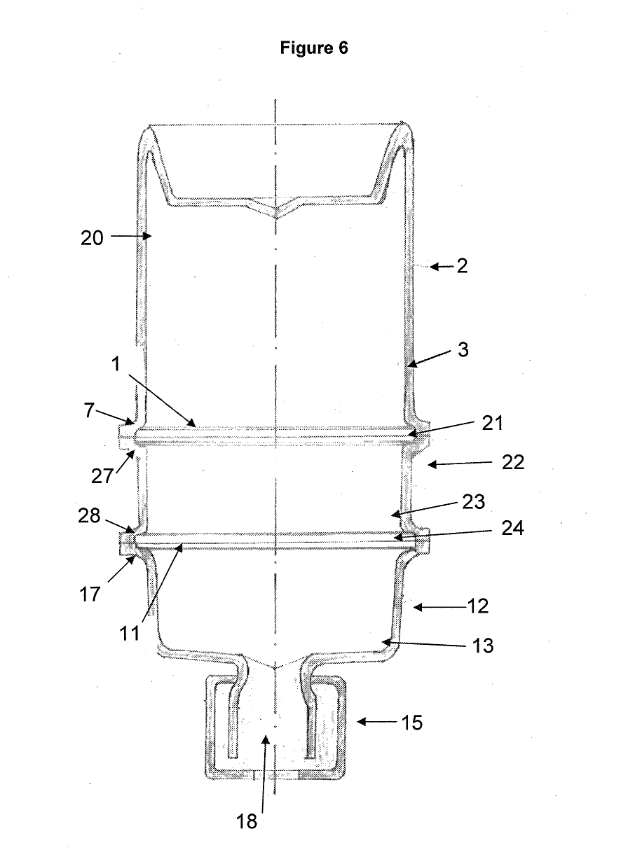

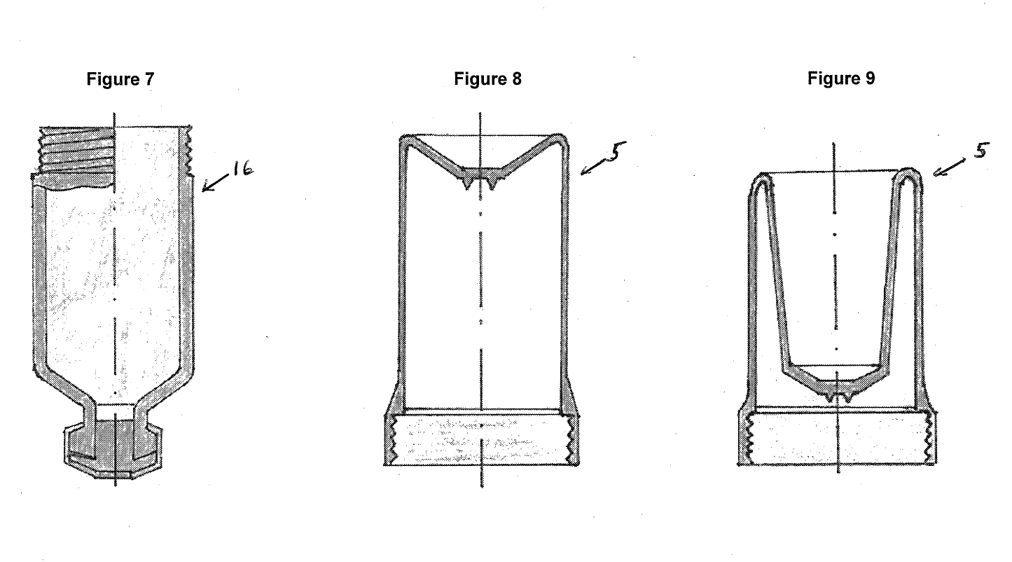

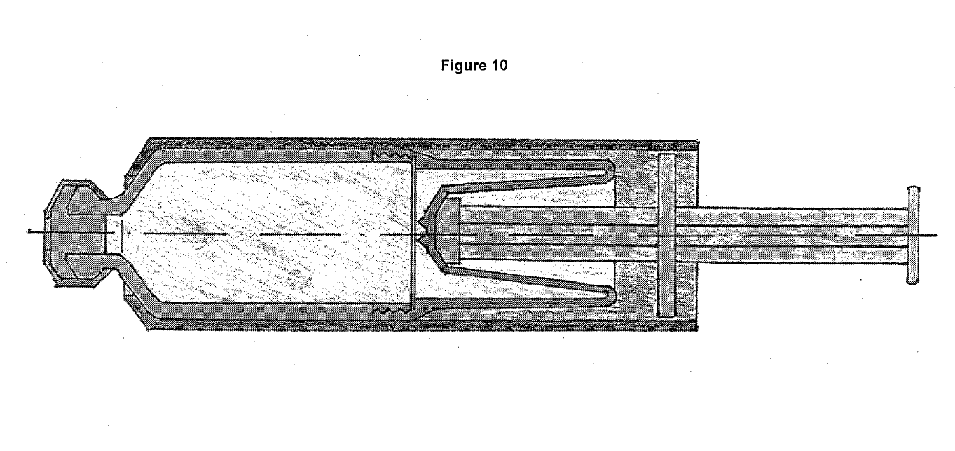

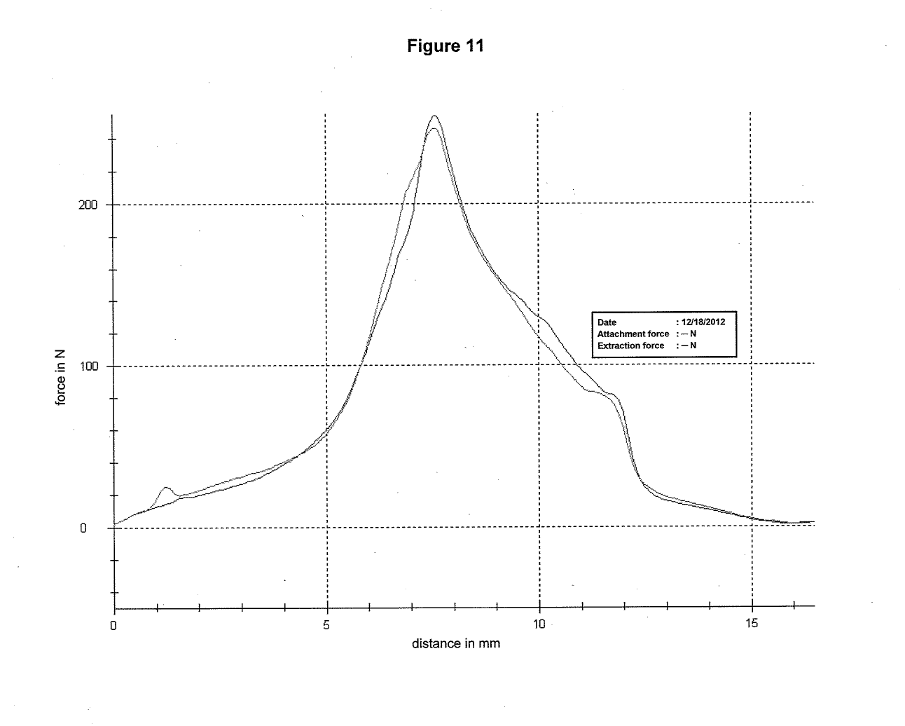

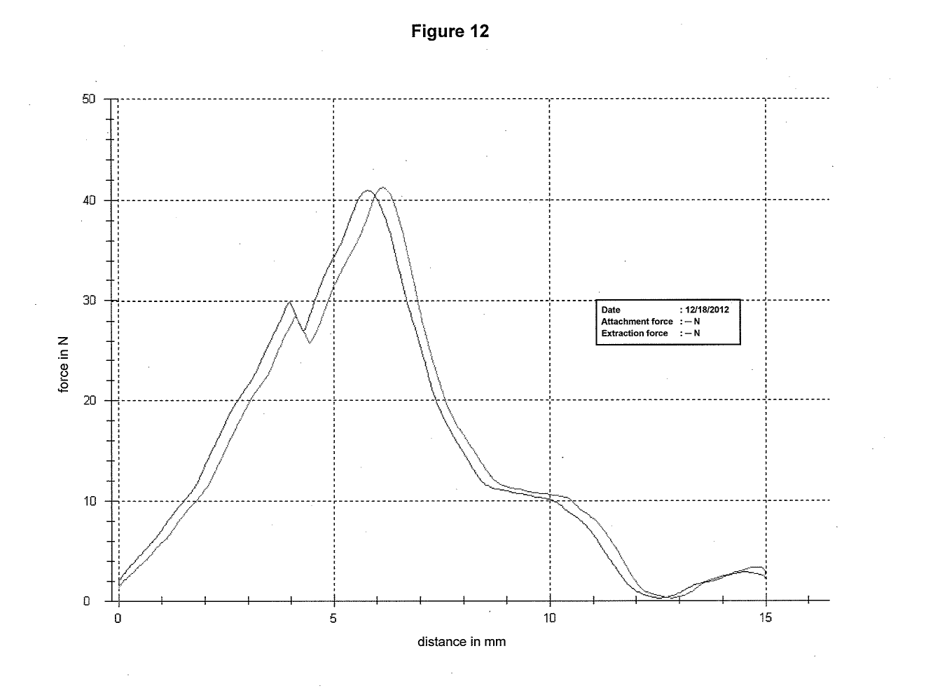

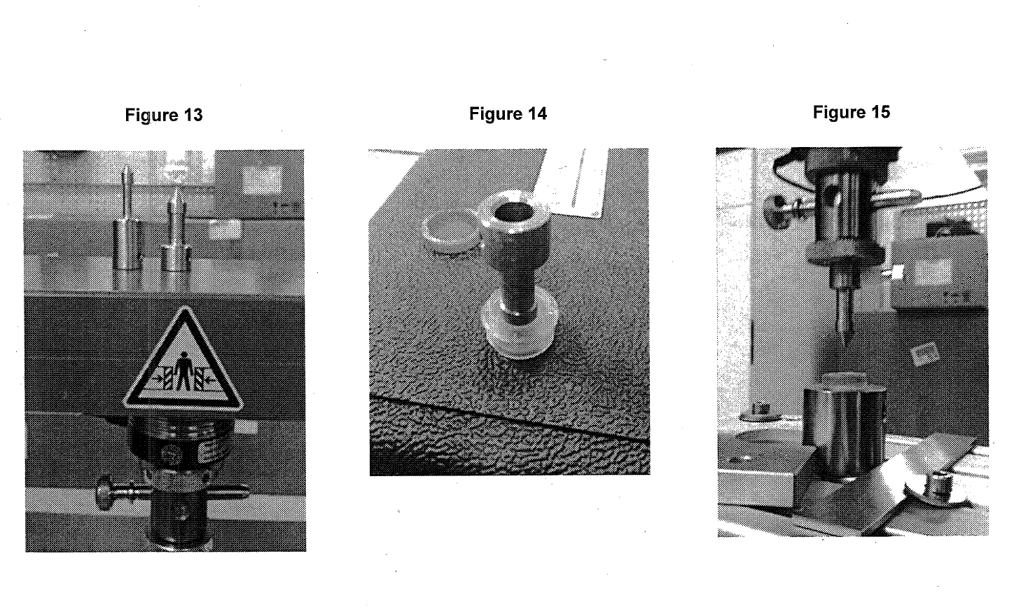

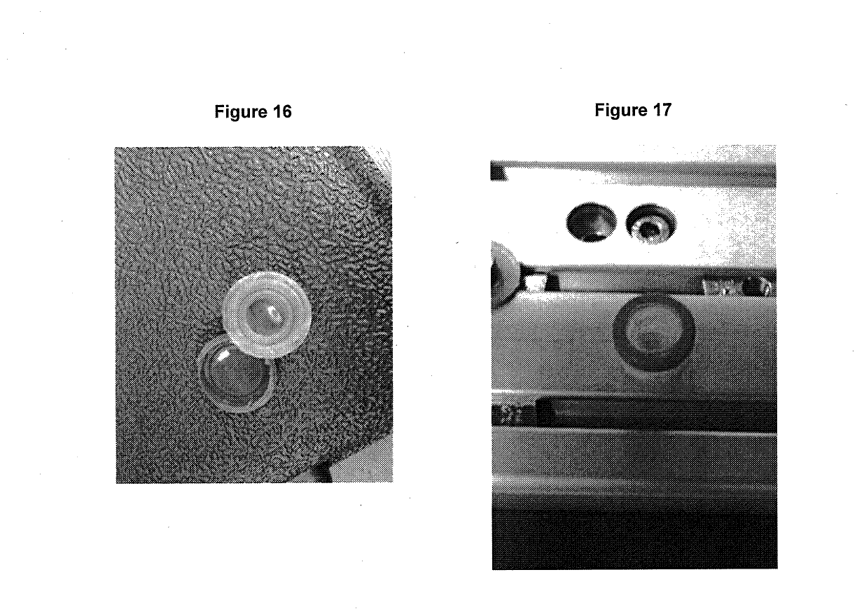

In a device, which corresponds to a setup as shown in FIG. 21 or 22 of WO 2010051369 A1, a bolt with a diameter of 9.9 mm was inserted into a cylinder with an inner diameter of 10.0 mm, in order to push through and afterwards overcome a membrane corresponding to the membrane 250 in the FIGS. 21 and 22 of WO 2010051369 A1. A commercially available element of a port system of the company B. Braun Melsungen AG was used. The membrane corresponding to the membrane 250 in the FIGS. 21 and 22 of WO 2010051369 A1 had a thickness of 0.2 mm. A second membrane corresponding to the membrane 250′ in the FIGS. 21 and 22 of WO 2010051369 A1 was not present. FIG. 11 shows the pressure course in Newton (N) over the distance traveled by the bolt (in mm) at a continuous speed of 200 mm/min, wherein after ca. 4 mm distance and a pressure of ca. 40 N the membrane is pushed through but afterwards a pressure of above 240 N is to be applied in order to overcome the membrane being pushed through and pressed to the inner wall of the cylinder with the bolt. It can be clearly recognized that after overcoming the membrane after ca. 8 mm a first and after 11 mm distance an additional clear and rapid pressure drop occurs, which leads to an uncontrolled axial movement of the plunger and can thus cause considerable injuries to a patient. Furthermore, the pressure drop cannot be controlled in a manually operated device for emptying a container as it was used for the determination of the pressure course shown in FIG. 12 and which corresponds to the containers according to FIGS. 21 and 22 of WO 2010051369 A1, so that at least one mechanical device for emptying has to be used mandatorily, which is impractical and causes additional expenses and represents a further disturbing source. The second curve in FIG. 11 shows the pressure course at a repeat test with identical experimental setup (double determination) in order to increase the significance of the experiment.

FIG. 12

In a device, which corresponds to a setup as shown in FIG. 21 or 22 of WO 2010051369 A1, a bolt with a diameter of minimally under 6.0 mm was inserted into a cylinder with an inner diameter of 6.0 mm, in order to push through and afterwards overcome a membrane corresponding to the membrane 250 in the FIGS. 21 and 22 of WO 2010051369 A1. A commercially available element of a port system of the company B. Braun Melsungen AG was used. The membrane corresponding to the membrane 250 in the FIGS. 21 and 22 of WO 2010051369 A1 had a thickness of 0.2 mm. A second membrane corresponding to the membrane 250′ in the FIGS. 21 and 22 of WO 2010051369 A1 was not present. FIG. 12 shows the pressure course in Newton (N) over the distance traveled by the bolt (in mm) at a continuous speed of 200 mm/min, wherein after ca. 6 mm distance the maximal force of slightly above 40 N is reached. It can be clearly recognized that after overcoming the membrane after ca. 6-7 mm distance a clear and rapid pressure drop occurs, but which is by no means as strong as shown in the previous example on FIG. 11, because the bolt is not jammed by the membrane parts abutting the wall. The second curve in FIG. 12 shows the pressure course at a repeat test with identical experimental setup (double determination) in order to increase the significance of the experiment.

FIG. 13 shows the bolts used in examples 3 and 4 (left: 6 mm, right: 9.9 mm). In example 11 the bolt with 9.9 mm diameter was used. The corresponding pressure curve measured with it is depicted in FIG. 11. In example 12 the bolt with 6 mm diameter was used. The corresponding pressure curve measured with it is depicted in FIG. 12.

FIG. 14 shows the 9.9 mm bolt in plug-in position.

FIG. 15 shows the setup of the apparatus with the port element before the puncture.

FIG. 16 shows the port element before the puncture.

FIG. 17 shows the port element after the puncture.

### EXAMPLES

### Example 1

An introversion container having a total volume of 10 ml containing 6 ml isotonic sodium chloride solution and a withdrawal container having a total volume of 10 ml containing a lyophilized bleomycin compound in a quantity of 6 mg are put together at the existing joining edges, which have a groove or tongue, and welded by exposure to heat under aseptic conditions in a laminar flow cabinet, so that the sealing foils of the two component containers are facing each other. The multi-chamber mixing container resulting in this way is put into carpule-like device, the device is closed, and mechanical pressure is exerted onto the bottom of the introversion container by the expression plunger of the device. The introversion container is gradually invaginated and the inner piercing piston pierces the two sealing foils between introversion container and withdrawal container. The pressure resulting from the diminishing volume of the introversion container leads to a rapid influx of the sodium chloride solution into the withdrawal container and to the dissolution of the lyophilized bleomycin compound. The introversion of the introversion container is facilitated by circumferential notch lines in the wall of the introversion container. The groove between introversion container and withdrawal container stops the introversion process. The excessive air escapes via the pressure-controlled exhaust valve of the withdrawal container. The introversion process is completed, when the introversion container was completely introverted into the withdrawal container. The bleomycin solution is withdrawn through the plug in the withdrawal area at the bottom side of the withdrawal container by the use of a cannula and transferred into a drip bag.

### Example 2

An introversion container having a total volume of 8 ml containing 5 ml isotonic sodium chloride solution is joined by gluing in a firmly bonded manner under sterile conditions with an intermediate container having a total volume of 4 ml containing 40 mg ibuprofen in powder form. At the other side of the intermediate container a withdrawal container having a total volume of 8 ml that contains 500 mg vitamin C in powder form is attached by gluing in a firmly bonded manner under sterile conditions. The introversion container is invaginated and the inner expression plunger pierces the two sealing foils between introversion- and intermediate container and subsequently the two sealing foils between intermediate- and withdrawal container. The introversion container has no notch lines and is completely invaginated into the volume of intermediate- and withdrawal container. The pressure resulting from the diminishing volume of the introversion container leads to a rapid influx of the sodium chloride solution into the withdrawal container and to the dissolution of the substances in powder form. The excessive air escapes via the pressure-controlled exhaust valve of the withdrawal container. The ibuprofen solution is withdrawn through the withdrawal area in form of a septum by the use of a needle and drawn into a syringe.

### Example 3

The FIGS. 13-17 show the experimental setup schematically. With the exception of the bolt used the setup is identical for both experiments.

FIG. 13 shows the bolts used (left: 6 mm, right: 9.9 mm). FIG. 14 shows the 9.9 mm bolt in plug-in position. FIG. 15 shows the setup of the apparatus with the port element before the puncture. FIG. 16 shows the port element before the puncture. FIG. 17 shows the port element after the puncture.

The particular bolt (figure A) is plugged into the receptacle of a commercially available tension testing machine and secured with a pin against slipping out (FIG. 15). The port element is inserted into a receptacle (FIG. 15) and aligned on the table centrally to the bolt. This position is fixed by stoppers. The test conditions are set at the tension testing machine. The traverse paths were determined with a calliper on the basis of a manually plunged bolt. Selected were:
Movement speed: 200 mm/min
Condition for termination: Reaching of a defined distance limit (depth of puncture)
Condition for start: Reaching of a pre-load of 2 N

After insertion of the port system into the holder the routine is started. The bolt travels at a defined speed up to a predefined distance. After reaching it the machine drives back automatically to its initial position.

### Example 4

Corresponds to example 3 except that a bolt with 6 mm diameter was used.

1-15. (canceled)

16. Multi-chamber mixing container comprising:
an introversion container; and
a withdrawal container;
wherein the introversion container is filled with a liquid and sealed with a pierceable sealing foil on the front side and its bottom is pushable in the direction of the sealing foil and the wall is introversible to the inside; and
wherein the withdrawal container is filled with a liquid or a solid and sealed on the top side with a pierceable sealing foil and has a withdrawal area at the bottom side; and
wherein the introversion container and the withdrawal container are connected with each other in a sealing manner.

17. Multi-chamber mixing container according to claim 16, wherein the front side of the introversion container sealed with the pierceable sealing foil and the top side of the withdrawal container sealed with the pierceable sealing foil are connected with each other in a sealing manner.

18. Multi-chamber mixing container according to claim 16, wherein the outer face of the introversion container has a groove, a bead, a thread or a recess at the level of the sealing foil and/or the withdrawal container has a groove, a bead, a thread or a recess at the level of the sealing foil.

19. Multi-chamber mixing container according to claim 16, wherein the bottom of the introversion container has a piercing nose or protrusion or bulge formed in the direction of the sealing foil and positioned centrally or the bottom is shaped concave.

20. Multi-chamber mixing container according to claim 19, wherein the piercing nose or the protrusion or the bulge or the concavely shaped bottom has canals, furrows, corrugations, star-shaped indentations, mounds, knobs, pins or other surface irregularities.

21. Multi-chamber mixing container according to claim 16, wherein the introversible wall of the introversion container has circumferential notch lines.

22. Multi-chamber mixing container according to claim 16, consisting of the introversion container and the withdrawal container and an intermediate container filled with a liquid or a solid and located in between the introversion container and the withdrawal container, wherein the intermediate container is sealed on the top side and on the bottom side with a pierceable sealing foil and the intermediate container is connected with the introversion container in a sealing manner and with the withdrawal container in a sealing manner.

23. Multi-chamber mixing container according to claim 16, consisting of the introversion container and the withdrawal container and two intermediate containers each filled with a liquid or a solid and located in between introversion container and withdrawal container, wherein both intermediate containers are sealed on the top side and on the bottom side with a pierceable sealing foil and both intermediate containers are connected with each other in a sealing manner and the first intermediate container is connected with the introversion container in a sealing manner and the other intermediate container is connected with the withdrawal container in a sealing manner.

24. Multi-chamber mixing container according to claim 16, wherein the multi-chamber mixing container consists of the introversion container and the withdrawal container and has on the outside along the connecting line between the introversion container and the withdrawal container a groove.

25. Multi-chamber mixing container according to claim 22, wherein the multi-chamber mixing container consisting of the introversion container, the intermediate container and the withdrawal container has on the outside along the connecting line between the introversion container and the intermediate container and/or between the intermediate container and the withdrawal container a groove

26. Multi-chamber mixing container according to claim 23, wherein the multi-chamber mixing container consisting of the introversion container, the two intermediate containers and the withdrawal container has on the outside along the connecting line between the introversion container and the first intermediate container and/or between the both intermediate containers and/or between the other intermediate container and the withdrawal container a groove.

27. Multi-chamber mixing container according to claim 22, wherein for the sealing connection between introversion container and intermediate container and between intermediate container and withdrawal container, the introversion container, the intermediate container and the withdrawal container have a groove, a bead, a thread or a recess at the level of the sealing foil.

28. Multi-chamber mixing container according to claim 23, wherein for the sealing connection between introversion container and the first intermediate container and between the first and the other intermediate container and between the other intermediate container and the withdrawal container, the introversion container, the first intermediate container, the other intermediate container and the withdrawal container have a groove, a bead, a thread or a recess at the level of the sealing foil.

29. Multi-chamber mixing container according to claim 16, wherein the introversion container is filled completely with a liquid.

30. Kit comprising at least one introversion container that is sealed with a pierceable sealing foil on the front side and its bottom is pushable in the direction of the sealing foil and the wall is introversible to the inside and at least one withdrawal container that is sealed on the top side with a pierceable sealing foil and has a withdrawal area at the bottom side, wherein, the introversion container and the withdrawal container are connectable with each other in a sealing manner.

31. Kit according to claim 30, further comprising at least one intermediate container that is sealed on the top side and on the bottom side with a pierceable sealing foil, wherein the intermediate container is connectable with the introversion container in a sealing manner and with the withdrawal container in a sealing manner.

32. Method for the aseptic preparation of a solution from at least two components, characterized by the insertion of a multi-chamber mixing container according to claim 16 in a device comprising a receptacle in the shape of a half-shell for the multi-chamber mixing container, mounting means for the multi-chamber mixing container and an expression plunger movable in the axial direction, exertion of pressure by the expression plunger onto the bottom of the introversion container, pushing the bottom of the introversion container in the direction of the withdrawal container, whereat the wall of the introversion container is continuously introverting to the inside and with onward pushing the sealing foils are pierced and mixing of the at least two components.
